(19) United States
(12) Patent Application Publication
(10) Pub. No.: US 2015/0349374 A1
(43) Pub. Date: Dec. 3, 2015

(54) Thin Film Battery with Magnetic Components

(71) Applicant: Apple Inc., Cupertino, CA (US)

(72) Inventors: Tetsuya Ishikawa, San Jose, CA (US); Penchala N. Kankanala, Santa Clara, CA (US); Alan Ritchie, Menlo Park, CA (US)

(21) Appl. No.: 14/722,071

(22) Filed: May 26, 2015

Related U.S. Application Data
(60) Provisional application No. 62/003,499, filed on May 27, 2014.

(51) Int. Cl. H01M 10/04

(52) U.S. Cl. CPC H01M 10/0436

(57) ABSTRACT

Solid-state battery structures and methods of manufacturing solid-state batteries, such as thin-film batteries, are disclosed. More particularly, embodiments relate to solid-state batteries that incorporate magnetic material in one or more layers. Other embodiments are also described and claimed.

This application claims the benefit of U.S. Provisional Patent Application No. 62/003,499, filed May 27, 2014, and this application hereby incorporates herein by reference that provisional patent application.

### BACKGROUND

1. Field

Embodiments relate to electrochemical devices and methods of manufacturing electrochemical devices. More particularly, embodiments relate to solid-state electrochemical devices, including batteries, which incorporate magnetic materials.

2. Background Information

Solid-state batteries, such as thin-film batteries, are known to provide better form factors, cycle life, power capability, and safety, as compared to conventional battery technologies. Solid-state battery structures and manufacturing methods, however, require further optimization to drive down production costs and enable broader adoption of solid-state batteries in a variety of applications.

Substrates for use in the fabrication of solid-state batteries have traditionally included ceramic, glass, and silicon planar wafers. More recently, solid-state batteries, such as thin-film batteries, have begun to include flexible substrates such as metal foils, to allow for more flexible and compact packages.

### SUMMARY

Manufacturing solid-state batteries with flexible substrates presents unique manufacturing challenges. For example, referring to FIG. 1, a battery cell 100 having a flexible substrate 102 supporting multiple thin film layers may have a tendency to bend, fold, or otherwise deform from a flat shape. Bending may result, for example, from the film layers 104 exhibiting different shrinkage rates and internal stresses during manufacturing, which can result in one layer being placed in tension and another in compression. This difference in stress distribution may lead to curling, bending, or deforming of the solid-state battery cell away from, e.g., a carrier tray 106 used during manufacturing. More particularly, curling of the solid-state cell may make subsequent picking and placing operations difficult or inaccurate, leading to increased manufacturing cost and/or time.

Embodiments of thin-film battery structures are disclosed. The thin-film battery structures may incorporate magnetic materials, which may allow the solid-state battery cell to be constrained in a flattened orientation during manufacturing. In an embodiment, an electrochemical device includes several layers, such as an electrolyte layer between an anode layer and a cathode layer. Furthermore, the electrochemical device includes at least one magnetic layer. For example, the magnetic layer 212 may have a relative magnetic permeability greater than 1.0, e.g., in a range between 1.0 and 1.0×10⁶. By way of example, the relative magnetic permeability may be in a range greater than 1,000, e.g., between 1,000 and 10,000. The magnetic layer may accordingly include a material such as iron, nickel, or cobalt.

In an embodiment, the magnetic layer is a cathode current collector in electrical communication with the cathode layer. Alternatively, the magnetic layer is an anode current collector in electrical communication with the anode layer. In an embodiment, both the cathode current collector and the anode current collector are magnetic layers.

In an embodiment, an electrochemical device may include a first electrochemical cell having a first group or set of film layers, as well as a second electrochemical cell having a second group or set of film layers, including a second anode layer, a second electrolyte layer, and a second cathode layer. The two anode layers may be located between the cathode layers. Furthermore, the electrochemical device may include a magnetic layer, such as a deposited film or separate magnetic strip. The cathode layer of the first electrochemical cell may be between the magnetic strip and the cathode layer of the second electrochemical cell.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

FIG. 1 is a cross-sectional view of an electrochemical cell experiencing a curling effect during a manufacturing process.

FIG. 2 is a cross-sectional view of an electrochemical cell having a magnetic layer in accordance with an embodiment.

FIG. 3 is a cross-sectional view of an electrochemical cell having a magnetic substrate layer in accordance with an embodiment.

FIG. 4 is a cross-sectional view of an electrochemical device having a stack of electrochemical cells and a magnetic layer in accordance with an embodiment.

FIG. 5 is a top view of several singulated electrochemical cells on an initial surface in accordance with an embodiment.

FIG. 6 is a top view of several singulated electrochemical cells on a magnetized surface in accordance with an embodiment.

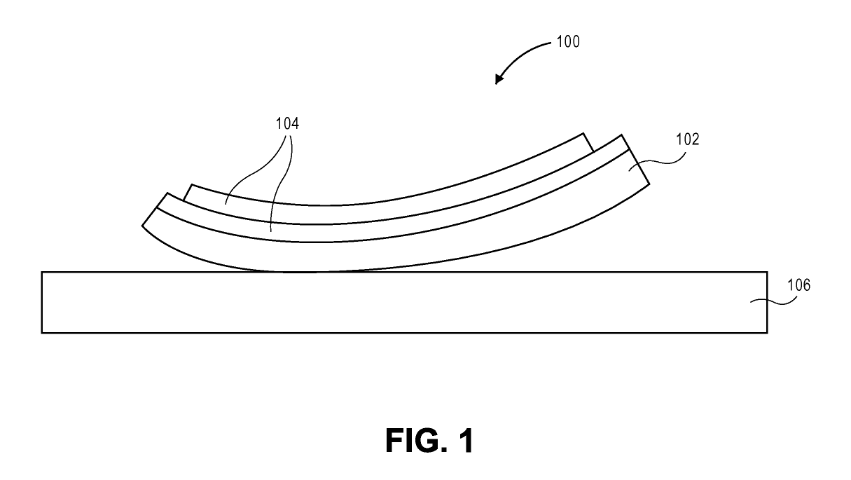

### DETAILED DESCRIPTION

Embodiments of the invention are structures and manufacturing methods for solid-state batteries, such as thin-film batteries. However, while some embodiments are described with specific regard to manufacturing processes or structures for integration within a solid-state battery, the embodiments are not so limited, and certain embodiments may also be applicable to other uses. For example, one or more of the embodiments described below may be used to manufacture other layered elements, such as silicon-based solar cells.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. The objects or relative positions shown in the drawings are not necessarily to scale, and may sometimes be exaggerated for the sake of easier understanding. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

In an aspect, an electrochemical cell and/or an electrochemical device having one or more magnetic layers incorporated in the cell or device structure is provided. In an embodiment, one or more of a cathode current collector, an anode current collector, a substrate layer, or a magnetic strip on a backside of an electrochemical cell or device is sufficiently magnetic such that an externally applied magnetic field attracts the cell or device to flatten the cell or device against a mating surface. Thus, the cell or device may be maintained in a flattened orientation during manufacturing. Furthermore, the magnetic electrochemical cell or device may be picked up and placed, using magnetic chucks for example, to facilitate picking, placing, and other assembly operations used to build an electrochemical device, such as a solid-state battery.

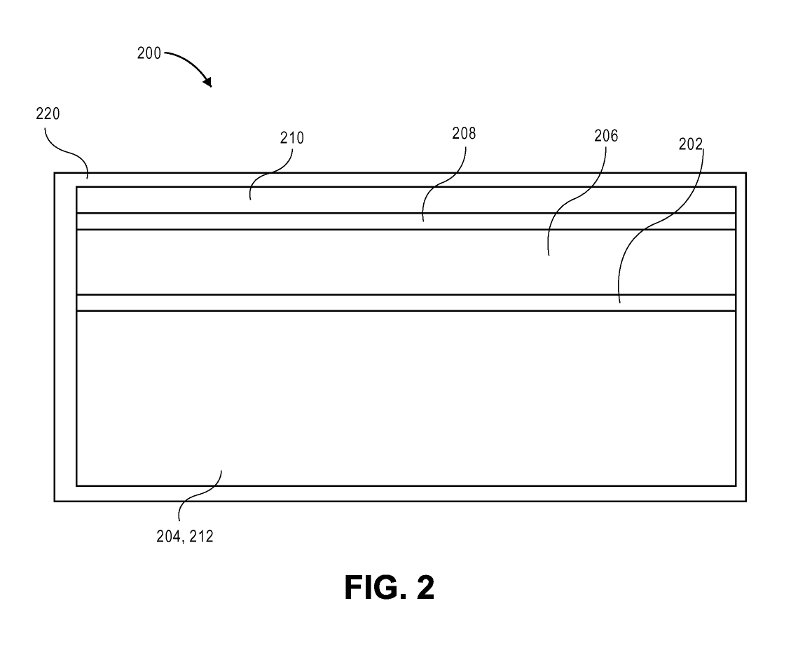

Referring to FIG. 2, a cross-sectional view of an electrochemical cell having a magnetic layer is shown in accordance with an embodiment. The electrochemical cell 200 may include an electrolyte layer 208 between an anode layer 210 and a cathode layer 206. The cathode layer 206 may, for example, include LiCoO₂, LiMn₂O₄, LiMnO₂, LiNiO₂, LiFePO₄, LiVO₂, or any mixture or chemical derivative thereof. The electrolyte layer 208 may facilitate ion transfer between the cathode layer 206 and an anode layer 210. Accordingly, the electrolyte layer 208 may be a solid electrolyte, which may not contain any liquid components and may not require any binder or separator materials compounded into a solid thin film. For example, the electrolyte layer 208 may include lithium phosphorous oxynitride (LiPON) or other solid state thin-film electrolytes such as LiAlF₄, Li₃PO₄ doped Li₄SiS₄. The anode layer 210 may, for example, include lithium, lithium alloys, metals that can form solid solutions or chemical compounds with lithium, or a so-called lithium-ion compound that may be used as a negative anode material in lithium-based batteries, such as Li₄Ti₅O₁₂.

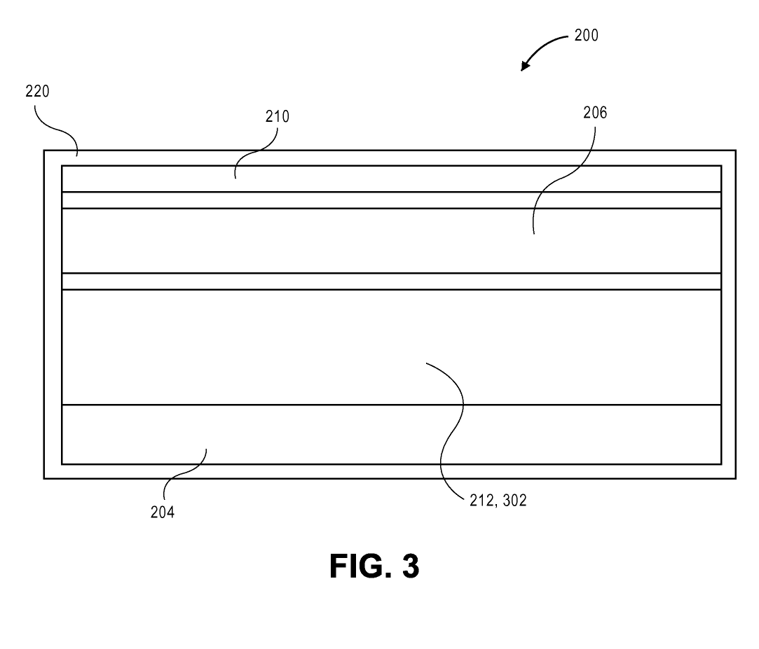

In an embodiment, the cathode layer 206 may be electrically connected with a cathode current collector 204, which may be an electrically conductive layer or a tab. Similarly, the anode layer 210 may be electrically connected with an anode current collector, which may be an electrically conductive layer or a tab. Optionally, one or more intermediate layers may be disposed between the cathode layer 206 or the anode layer 210 and its respective current collector. For example, a barrier film layer 202 may separate the cathode layer 206 from the cathode current collector 204. For example, the barrier film layer 202 may be in direct physical contact with, and in between, the cathode layer 206 and the cathode current collector 204. The barrier film layer 202 may reduce the likelihood of contaminants and/or ions from diffusing between the cathode current collector 204 and the cathode layer 206. Thus, the barrier film layer 202 may include materials that are poor conductors of ions, such as borides, carbides, diamond, diamond-like carbon, silicides, nitrides, phosphides, oxides, fluorides, chlorides, bromides, iodides, and compounds thereof. Alternatively, an additional intermediate layer, such as a substrate layer, may be disposed between the cathode layer 206 and the cathode current collector 204—see FIG. 3. The substrate layer may, for example, provide electrical connectivity between the cathode layer 206 and the cathode current collector 204 and may also provide structural support, e.g., rigidity, to the electrochemical cell 200. Accordingly, the substrate layer may include a metal foil or another electrically conductive material. It should be noted that while FIG. 2 shows a barrier layer 202, this layer may not be needed in all instances of the electrochemical cell 200, and can therefore be omitted in certain embodiments.

In some instances, the electrochemically active layers of the cell may be formed on one side of the substrate layer, e.g., using material deposition techniques such as physical vapor deposition, and the cathode current collector 204 may be formed separately and physically coupled to another side of the substrate layer. In other instances, the electrochemically active layers of the cell may be formed on the substrate layer, and then the electrochemically active layers may be removed from the substrate layer and physically coupled to the separately formed cathode current collector 204. In still other instances, the electrochemically active layers of the cell may be formed, e.g., physical vapor deposited, directly on the cathode current collector 204. Thus, there are many different ways to create an electrochemical cell 200 having at least several electrochemically active layers forming an anode, a cathode and electrolyte.

The electrochemical cell 200 may be a thin film battery cell, having thin layers. For example, the cathode current collector 204 may have a thickness in a range of between 10 to 100 μm, e.g., 50 μm. The composite electrochemical cell 200 may have a total thickness in a range of between 13 to 300 μm. For example, the barrier film layer 202, cathode layer 206, electrolyte layer 208, and anode layer 210 may combine to have a thickness in a range of between 3 to 290 μm, e.g., 25 μm.

In an embodiment, at least one of the layers of the electrochemical cell 200 may be magnetic. For example, a magnetic layer 212 may be one of the layers described above, or it may be a separate layer or tab incorporated into the electrochemical cell 200 (in addition to the layers described above). Furthermore, multiple layers of the electrochemical cell 200 may be magnetic. For example, the electrochemical cell 200 may include an anode current collector and a cathode current collector 204, and both of the current collectors may be magnetic. Furthermore, each magnetic layer 212 in an electrochemical cell 200 may be wholly or partially formed from magnetic materials (including for example permanent magnet materials). Several embodiments of a magnetic layer 212 are described below.

In an embodiment, the magnetic layer 212 may be part of the cathode current collector 204. The cathode current collector 204 may also be metallic and/or electrically conductive. For example, the cathode current collector 204 may be a metal foil. The metal foil may be wholly or partially made from a magnetic material. More particularly, the metal foil may be ferromagnetic or ferrimagnetic, meaning that at least some of the magnetic ions in the magnetic layer 212 add a positive contribution to a net magnetization of the metal foil. Accordingly, the cathode current collector 204 may be attracted to a magnet, such as a permanent magnet or an activated electromagnet.

The magnetic layer 212, e.g., a magnetic cathode current collector 204, may include any of numerous ferromagnetic materials, or compounds thereof. In an embodiment, the cathode current collector 204 includes Co, Fe, Fe₂O₃, FeOFe₂O₃, NiOFe₂O₃, CuOFe₂O₃, MgOFe₂O₃, MnBi, Ni, MnSb, MnOFe₂OC, Y₃Fe₅O₁₂, CrO₂, MnAs, Gd, Dy, EuO, or any other crystalline or non-crystalline ferromagnetic or ferrimagnetic materials. For example, the magnetic layer 212 may include a layer of rare-earth magnetic material or incorporate particles of such material. Examples of materials with ferromagnetic properties that may be suitably incorporated in the cathode current collector 204 include iron, magnetic nickel alloys such as Mu-metal, cobalt-iron, permalloy, electrical steel, ferritic stainless steel, martensitic stainless steel, and ferrite, to name a few.

The magnetic properties of the magnetic layer 212, which may be the cathode current collector 204, can be qualitatively and quantitatively described. In an embodiment, the magnetic strength of the magnetic layer 212 may be sufficient to cause a curled electrochemical cell 200 to be attracted toward a magnetic field with sufficient force such that the electrochemical cell 200 will flatten against a surface in the direction of attraction. For example, an electrochemical cell 200 having the magnetic layer 212 may be located on a surface, such as a carrier tray or the like, in a curled configuration after bending, folding, or otherwise deforming. Upon application of a magnetic field, the magnetic layer 212 may be drawn toward the surface, such as a carrier tray, with sufficient force that the electrochemical cell 200 flattens against the surface. Accordingly, the attractive force between the magnetic layer 212 and the applied magnetic field must be high enough to overcome the internal stresses that cause the electrochemical cell 200 to curl.

One measure of magnetic strength that may be used to quantify the magnetic layer 212 is magnetic permeability. In an embodiment, the relative permeability of magnetic layer 212, i.e., the ability of the magnetic layer 212 to support the formation of a magnetic field within itself, may be sufficient to cause the magnetic layer 212 to be attracted toward a magnetic field with sufficient force to flatten the electrochemical cell 200 from a curled configuration. For example, in an embodiment, the magnetic layer 212 may have a relative permeability greater than 1.0. In an embodiment, the magnetic layer 212 may have a composite relative permeability within a range greater than 1.0, meaning that portions of the magnetic layer 212 may be higher or lower, but the composite structure of the magnetic layer 212 behaves like a material having a relative permeability greater than 1.0, e.g., in a range of 1.0 to 1.0×10⁶. By way of example, the composite relative magnetic permeability may be in a range greater than 1,000, e.g., between 1,000 and 10,000. In an embodiment, the magnetic layer 212 may have a sufficient composite relative permeability, meaning that portions of the magnetic layer 212 may have higher or lower relative permeability, but the composite structure of the magnetic layer 212 behaves like a material having a relative permeability sufficient to cause the magnetic layer 212 to be attracted toward a magnetic field with sufficient force to flatten the electrochemical cell 200 from a curled configuration. Composite relative permeability may apply, for example, to a cathode current collector 204 having a metal alloy loaded with particles of rare earth magnets. In such case, the composite relative permeability of the cathode current collector 204 may be between the individual relative permeabilities of the constituent metal alloy and rare earth magnets.

Permeability of ferromagnetic materials varies with field strength, and thus, the attraction and flattening of the magnetic layer 212 and electrochemical cell 200 may depend on the strength of the applied magnetic field. The magnetic field may be generated by a permanent magnet or an activated electromagnet located adjacent to or near the magnetic layer 212. For example, the applied magnetic field may be high enough to penetrate all layers of the electrochemical cell 200, or an electrochemical device incorporating the electrochemical cell 200, and to draw the electrochemical cell 200 toward a surface, such as a carrier tray.

In an embodiment, electrochemical cell 200 may be an encapsulated electrochemical cell. More particularly, electrochemical cell 200 (or an electrochemical device having electrochemical cell 200) may include an encasing layer 220 that covers all or a portion of one or more of the layers of electrochemical cell 200. For example, encasing layer 220 may include a packaging or sealing film that is disposed over anode layer 210, cathode current collector 204, or any of the other layers of electrochemical cell 200 (such as by covering the sidewall of the cell). The encasing layer 220 may therefore provide a barrier between electrochemical cell 200 and a surrounding environment. In an embodiment, encasing layer 220 is a portion of a packaging enclosure that contains electrochemical cell 200. Thus, although encasing layer 220 is illustrated as being a uniform layer around the entirety of electrochemical cell 200 in FIG. 2, the protective and or insulating layer may instead extend in a planar fashion that only covers a portion of the other layers, e.g., encasing layer 220 may cover anode layer 210, but not cover the sidewalls or a layer opposite from anode layer 210. Nonetheless, encasing layer 220 may be considered to at least partly encase, encapsulate, or contain electrochemical cell 200.

FIG. 3 is a cross-sectional view of an electrochemical cell having a substrate layer in accordance with an embodiment. In an embodiment, the magnetic layer 212 may be part of a substrate layer 302 placed in electrical communication between the cathode layer 206 and the cathode current collector 204. In an embodiment, the cathode layer 206 may be deposited over the substrate layer 302. Alternatively, the substrate layer 302 may be bonded to the cathode layer 206 using an electrically conductive paste or conductive pressure sensitive adhesive. The substrate layer may be formed from conductive material, such as metal foil, and thus may act as a cathode current collector. That is, the substrate layer 302 may conduct electricity directly to external components without the need for a separate cathode current collector. Alternatively, the substrate layer 302 may conduct electricity between the cathode layer 206 and a separate cathode current collector. For example, the substrate layer 302 may conduct electricity to cathode current collector 204, which may be a separate layer bonded to the substrate layer 302 using, e.g., a conductive paste. Alternatively, the cathode current collector 204 may be a tab connected to only a portion, e.g., an edge portion, of the substrate layer 302. Thus, the magnetic layer 212 may be the substrate layer 302, and the substrate layer 302 may electrically connect the cathode layer 206 with external circuitry, e.g., through itself and/or through a separate cathode current collector 302 being, in one case, a tab.

Since the substrate layer 302, whether separate from or integral to the cathode current collector 204, may be magnetic, the substrate layer 302 may be formed from and/or incorporate ferromagnetic or ferrimagnetic materials with sufficient composite permeability to cause the electrochemical cell 200 to be attracted toward an externally applied magnetic field. Accordingly, the materials, compounds, and general magnetic properties of the substrate layer 302 may be consistent with those described above.

As discussed above, electrochemical cell 200 may be an encapsulated electrochemical cell. More particularly, electrochemical cell 200 (or an electrochemical device having electrochemical cell 200) may include an encasing layer 220 that covers all or a portion of one or more of the layers of electrochemical cell 200. For example, encasing layer 220 may include a packaging or sealing film that is disposed over anode layer 210, cathode current collector 204, or any of the other layers of electrochemical cell 200 (such as by covering the sidewall of the cell). As shown in FIG. 3, magnetic layer 212 may be between anode layer 210 and cathode current collector 204, and thus, by sealing one or more of those layers, encasing layer 220 may also be considered to encase magnetic layer 212. As mentioned above, the encasing layer 220 may provide a barrier between electrochemical cell 200 and a surrounding environment, and may be a part of a packaging enclosure that covers a portion of the cell, but is spaced apart from other portion of the cell. Thus, although encasing layer 220 is illustrated as being a uniform layer around the entirety of electrochemical cell 200 in FIG. 3, encasing layer 220 may cover anode layer 210, but not cover the sidewalls or a layer opposite from anode layer 210.

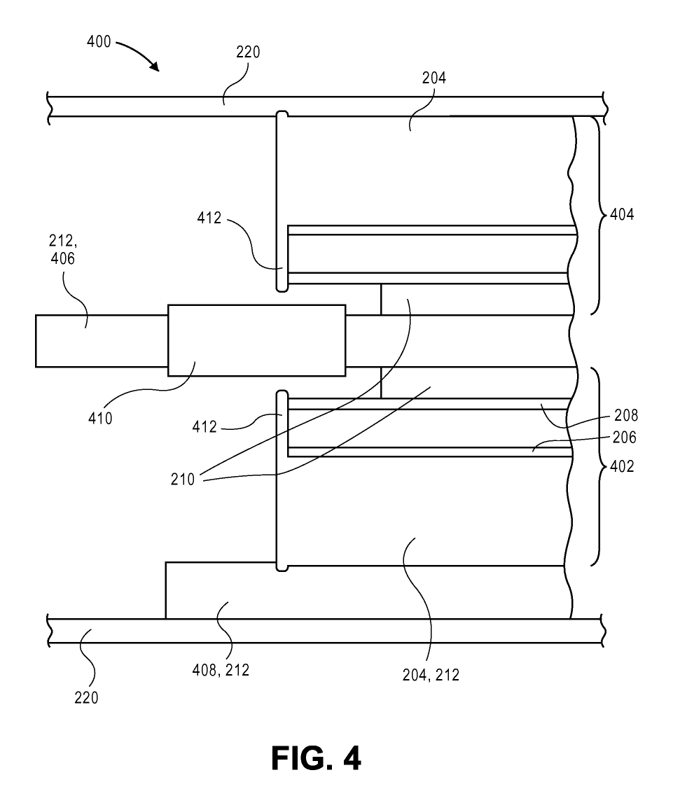

FIG. 4 is a cross-sectional view of an electrochemical device having a stack of electrochemical cells and a magnetic layer in accordance with an embodiment. In an embodiment, a first electrochemical cell 402 and a second electrochemical cell 404 may be stacked to form an electrochemical device 400. More particularly, an anode layer 210 of the first electrochemical cell 402 may be in electrical contact with an anode layer 210 of the second electrochemical cell 404. For example, the anode layers 210 may be in contact with opposing faces of an intermediate conductive layer, such as anode current collector 406 as shown. The stacked configuration of the electrochemical device 400, which may be a solid-state battery such as a thin-film battery, may provide for efficient packaging and a compact product form factor.

In an embodiment, the electrochemical device 400 may include a magnetic layer 212. For example, the magnetic layer 212 may be a part of the anode current collector 406 incorporated into or placed in electrical communication with the two anode layers 210. The anode current collector 406 may be, for example, a metal film bonded or deposited onto one or both of the anode layers 210. For example, the anode current collector 406 may be a metal film that is bonded to the anode layer 210 using an electrically conductive paste or conductive pressure sensitive adhesive. Alternatively, the anode current collector 406 may be fabricated on top of the anode layer 210 using, e.g., electron beam evaporation. Thus, the anode current collector 406 may engage with only a portion of an anode layer 210 surface, such as an outer edge (or side) of the anode layer 210, or may be located across an entire outer surface (or face) of the anode layer 210. Since the magnetic layer 212 may be the anode current collector 406, the anode current collector 406 may be formed from and/or incorporate ferromagnetic or ferrimagnetic materials with sufficient composite permeability to cause the electrochemical cell 200 to be attracted toward an externally applied magnetic field. Accordingly, the materials, compounds, and general magnetic properties of the anode current collector 406 may be consistent with those described above.

In one embodiment, one or more separate magnetic layers 212 may be added to the electrochemical cell 200 or the electrochemical device 400. In an embodiment, a magnetic strip 408 may be included in the cell or device to allow the cell or device structure to be attracted to an externally applied magnetic field. For example, a magnetic strip 408 may be bonded to a back surface (or back face) of the cathode current collector 204 of at least one of the electrochemical cells 402, 404 in the electrochemical device 400 (where it is understood that the front face of the cathode current collector 204 may be in direct electrical contact with the cathode 210). For example, respective magnetic strips 408 may be bonded on each cathode current collector 204 to sandwich the electrochemical cells 402, 404 therebetween. Thus, because the magnetic layer 212 may be the magnetic strip 408, the materials, compounds, and general magnetic properties of the magnetic strip 408 may be consistent with those described above.

In an embodiment, an electrochemical cell 200 or electrochemical device 400 may include more than one magnetic layer 212. For example, an electrochemical device 400 may include multiple magnetic layers 212, including for example a magnetic cathode current collector 204 and a magnetic anode current collector 406. Also, other layers of the electrochemical device 400 may be magnetic, in addition to the current collectors. For example, the multiple magnetic layers 212 may further include a magnetic strip 408 coupled with a back face of a cathode current collector 204.

In various embodiments, a magnetic layer 212 may include a ferromagnetic portion formed from ferromagnetic material and a non-ferromagnetic portion formed from non-ferromagnetic material. For example, the magnetic layer 212 may have a laminate structure with only a portion of the laminate being a magnetic material. Given that electrical conductivity may be desirable for certain components, such as for the anode current collector 406, a magnetic version of the anode current collector 406 may be a composite material, e.g., a laminate structure, having both ferromagnetic and non-ferromagnetic materials. For instance, a magnetic version of the anode current collector 406 may include a first laminate layer that is ferromagnetic and thus attracted to an externally applied magnetic field, as well as a second laminate layer that is non-ferromagnetic. The second laminate layer may be bonded to the first laminate layer and may have higher electrical conductivity than the first laminate layer, to provide a monolithic anode current collector 406 structure that is both magnetic and electrically conductive.

In an embodiment, the magnetic layer 212 incorporated in or on an electrochemical cell 200 or device 400 may include a magnetic coating. For example, manganese ferrite nanoparticles may be applied over an outer surface of the cathode current collector 204, the substrate layer 302, or any other layer, to cause the coated surface to be magnetically attracted to an externally applied magnetic field. Other coatings, such as magnetic paints, may be similarly applied to form a magnetic layer 212 within the scope of this description. Given the above description, it is noted that there are several ways to make a particular material layer magnetic, including by incorporating magnetic particles or plugs, forming the material layer entirely from a ferromagnetic material, or even forming only a portion of the material layer from a ferromagnetic layer. Thus, the overall structure of a magnetic layer 212 may be provided with magnetic characteristics in numerous ways. Accordingly, it is to be understood that the one or more magnetic layers 212 in an electrochemical cell 200 or device 400 may be magnetic, without regard to whether all, or only portions of, the magnetic layers 212 are formed from magnetic material.

In an embodiment, a current collector, such as anode current collector 406, which contacts opposing faces of device 400 layers, may have at least a portion of its outer surface covered by an insulator 410 to reduce the likelihood of shorting of the layers of the electrochemical device 400. For example, a region of the exposed surface of the anode current collector 406 may be covered with an insulating material to reduce the likelihood of electrical shorting between anode current collector 406 and another component of the electrochemical device 400. In an embodiment, laser cutting of the electrochemical cells 200, which may occur during singulation of the cells from a larger sheet of multi-layered material, creates a slag layer 412 across a sidewall of the first electrochemical cell 402 and/or the second electrochemical cell 404. The slag layer 412 may result from melting of material, such as metal in substrate layer 302, and redepositing of the melted material across the sidewall. If the slag layer 412 is blown too far across the sidewall, or if the anode current collector 406 is flexed such that contact is made between the anode current collector 406 and the slag layer 412, electrical and/or ionic shorting can occur between the anode current collector 406 and the cathode current collector 204 and/or the substrate layer 302 (see FIG. 3). Shorting between the anode current collector 406 and other layers may also occur regardless of whether a slag layer 412 is present. Thus, to reduce the likelihood of electrical and/or ionic shorting, the insulator 410 may cover at least a portion of the anode current collector 406 to reduce the likelihood that the anode current collector 406 will contact another cell layer. The insulator 410 may include any number of insulating materials and may be applied to the anode current collector 406 in numerous manners. For example, the insulator 410 may be a parylene film that is chemical vapor deposited over the anode current collector 406 between the sidewalls of the first and second electrochemical cells, 402, 404, and/or between opposing slag layers 412 covering the sidewalls. Alternatively, the insulator 410 may include a heat shrink tubing, e.g., a polyolefin heat shrink tube, which may be located over and shrunk around the anode current collector 406. Furthermore, the insulator 410 may be an insulating tube, such as a polyimide tube, bonded over the anode current collector 406 at the appropriate location to reduce the likelihood of shorting between the anode current collector 406 another cell layer or the slag layer 412.

Electrochemical device 400 having stacked electrochemical cells 402 and 404 may be packaged within an enclosure to form a barrier between the cells and the surrounding environment. More particularly, cells may be contained by one or more encasing layer 220. Encasing layers 220 may be, for example, portions of a packaging enclosure of electrochemical device 400. For example, the stacked electrochemical cells 402, 404 of electrochemical device 400 may be contained within an enclosure having walls surrounding the cells, and the encasing layer(s) 220 may provide one or more of the walls. As such, encasing layer 220 may cover an outer surface of the electrochemical cells 402 and/or 404 and essentially form an outer envelope and an outer surface of electrochemical device 400. More particularly, encasing layer 220 may cover at least a portion of an outer surface of electrochemical cell 402 or electrochemical cell 404, such as an outer surface of magnetic strip 408 and/or an outer surface of cathode current collector 204. By covering an outer surface of at least one of the layers of the electrochemical cells 402, 404, the encasing layer 220 may be considered to at least partly cover the layers of the cells.

As described above, an electrochemical cell 200 or device 400 may be magnetically attracted by an external permanent magnet or electromagnet. This magnetic characteristic of the cell or device may be utilized during manufacturing to make assembly of a solid-state battery faster and more accurate.

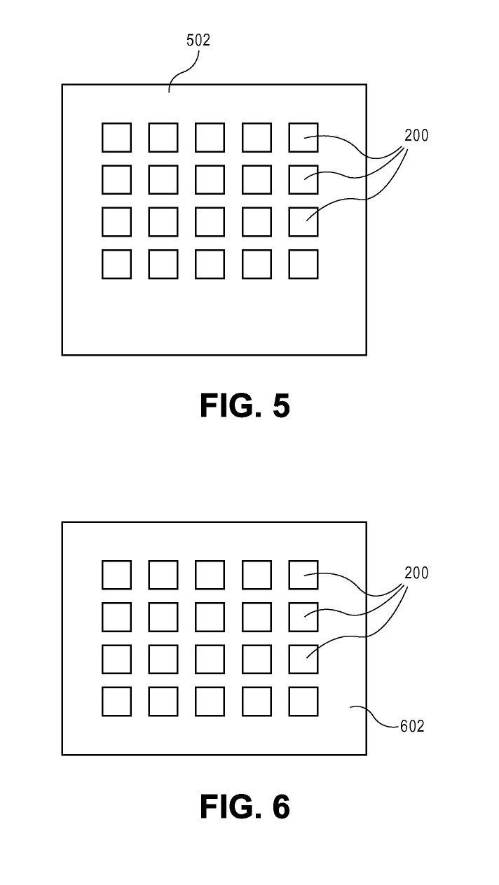

FIG. 5 is a top view of a group of singulated electrochemical cells on an initial surface in accordance with an embodiment. To manufacture a solid-state battery having multiple (two or more) electrochemical cells stacked to form an electrochemical device 400, each electrochemical cell 200 may be formed on an initial tray 502. For example, in an embodiment, the initial tray 502 includes one or more electrochemical cells 200. In an embodiment, the electrochemical cells 200 may have residual internal material stresses induced during cell fabrication. These stresses may vary in their constituent cathode layer 206 and anode layer 210, which may cause each electrochemical cell 200 to curl. Alternatively, the cathode layer 206 may be flat until the anode layer 210 is patterned over the cathode layer 206, at which point the electrochemical cell 200 may curl. Accordingly, there may be a need to maintain the electrochemical cells 200 in a flattened configuration so that the cells 200 may be picked up, placed in a stacked configuration, and otherwise manipulated during manufacturing of a solid-state battery.

FIG. 6 is a top view of several singulated electrochemical cells on a magnetized surface, in accordance with an embodiment. In an operation, the electrochemical cells 200 may be carried from the initial tray 502 to an intermediate tray 602 for further processing. For example, an end effector for thin material handling, such as adhesive tape, may be used to pick up one or more electrochemical cells 200 from the initial tray 502 to transfer the cells to the intermediate tray 602. The adhesive tape may be any tape material that is inert to a top layer, e.g., a lithium anode layer 210, of the battery. The top layer may be a different layer of the battery, e.g., cathode layer 206, since the cell can be stacked in a reverse order of that shown. For example, the adhesive tape may be a polyimide film with an acrylic adhesive. Thus, a sticky side of the adhesive tape may be pressed against the electrochemical cells 200 (before or after singulation from the multi-layered sheet) to grip the electrochemical cells 200 and to flatten the electrochemical cells 200 through contact with the flat tape surface.

In an alternative embodiment, vacuum chucks may be used to grip and transfer the electrochemical cells 200 from the initial tray 502 to the intermediate tray 602. Furthermore, in an embodiment, each of the electrochemical cells 200 incorporates a magnetic layer 212 and may be picked up from the initial tray 502 using, e.g., an electromagnetic chuck that can be placed in apposition with the electrochemical cell 200 and then activated to attract and grip the electrochemical cell 200 in a flattened configuration.

The electrochemical cells 200 may thus be gripped and transferred to the intermediate tray 602 for further processing, such as stacking of the cells into an electrochemical device 400. To maintain the cells in a flattened configuration during further processing, the intermediate tray 602 may apply a magnetic field to the cells. For example, the intermediate tray 602 may include permanent magnets. The permanent magnets may apply a sufficient magnetic field to pull the cells away from the adhesive tape and/or transfer chucks and to retain the cells in a flattened configuration against the intermediate tray 602. In an alternative embodiment, the magnetic field applied by the intermediate tray 602 may be transient, i.e., the intermediate tray 602 may be an electromagnet that is activated to attract and flatten the cells, and then deactivated to allow, e.g., a magnetic or vacuum chuck to lift the cells away from the intermediate tray 602.

Since the electrochemical cells 200 may be flattened against the intermediate tray 602 and retained stably in a known location, the accuracy of gripping the electrochemical cells 200 by a chuck, such as an electromagnetic chuck, may be improved. Accordingly, each cell 200 may be retained in the flattened position to allow a secondary chuck to quickly and precisely pick up the cells 200 and stack them to form an electrochemical device 400. The stacked cells 200 of the electrochemical device 400 may furthermore be flattened by an externally applied magnetic field from, e.g., a chuck or the intermediate tray 602, until the electrochemical device 400 is fully built up. After the stacking is performed, the tendency of the cells to curl may be sufficiently resisted by the composite stacked structure such that biasing from an external magnetic field is no longer necessary. Thus, the magnetic field may be discontinued and the stacked electrochemical device 400 may be packaged into a solid-state battery and/or a product incorporating a solid-state battery.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. An electrochemical device, comprising:
a plurality of layers including an electrolyte layer between an anode layer and a cathode layer, and a magnetic layer, wherein the plurality of layers and the magnetic layer are part of an encapsulated electrochemical cell.

2. The electrochemical device of claim 1 further comprising a cathode current collector electrically connected with the cathode layer, wherein the magnetic layer is part of the cathode current collector.

3. The electrochemical device of claim 1 further comprising a substrate layer and a cathode current collector, the substrate layer electrically connected with the cathode layer and the cathode current collector, wherein the magnetic layer is part of the substrate layer.

4. The electrochemical device of claim 1 further comprising an anode current collector electrically connected with the anode layer, wherein the magnetic layer is part of the anode current collector.

5. The electrochemical device of claim 1 further comprising a second magnetic layer and a current collector, the current collector electrically connected with one or more of the anode layer or the cathode layer, wherein the second magnetic layer is part of the current collector.

6. The electrochemical device of claim 5, wherein the current collector is an anode current collector electrically connected with the anode layer.

7. The electrochemical device of claim 5, wherein the current collector is a cathode current collector electrically connected with the cathode layer.

8. An electrochemical device, comprising:
a first encapsulated electrochemical cell having a first plurality of layers including a first electrolyte layer between a first anode layer and a first cathode layer, and a first magnetic layer; and
a second encapsulated electrochemical cell having a second plurality of layers including a second electrolyte layer between a second anode layer and a second cathode layer, and a second magnetic layer;
wherein the first and second anode layers of the first and second encapsulated electrochemical cells are electrically connected with each other between the first and second cathode layers of the first and second encapsulated electrochemical cells.

9. The electrochemical device of claim 8, wherein the first encapsulated electrochemical cell includes a first cathode current collector electrically connected with the first cathode layer, and wherein the first magnetic layer is part of the first cathode current collector.

10. The electrochemical device of claim 8, wherein the first encapsulated electrochemical cell includes a first substrate layer and a first cathode current collector, the first substrate layer electrically connected with the first cathode layer and the first cathode current collector, wherein the first magnetic layer is part of the first substrate layer.

11. The electrochemical device of claim 8, wherein the first encapsulated electrochemical cell includes a first anode current collector electrically connected with the first anode layer, and wherein the first magnetic layer is part of the first anode current collector.

12. The electrochemical device of claim 8, wherein the first encapsulated electrochemical cell includes a third magnetic layer, wherein the first plurality of layers includes a first anode current collector electrically connected with the first anode layer, and wherein the third magnetic layer is part of the first anode current collector.

13. The electrochemical device of claim 8, wherein the first and second magnetic layers have relative magnetic permeabilities greater than 1,000.

14. The electrochemical device of claim 13, wherein one or more of the first or second magnetic layers have a ferromagnetic portion including a material selected from a group consisting of nickel, cobalt, and iron.

15. An electrochemical device, comprising:
an encasing layer;
a magnetic layer; and
a plurality of layers including an electrolyte layer between an anode layer and a cathode layer, wherein the magnetic layer and the plurality of layers are at least partly covered by the encasing layer.

16. The electrochemical device of claim 15, wherein the plurality of layers includes a current collector electrically connected with one or more of the anode layer or the cathode layer, and wherein the magnetic layer covers an outer surface of the current collector.

17. The electrochemical device of claim 16, wherein the current collector is a cathode current collector electrically connected with the cathode layer, and wherein the magnetic layer includes a magnetic strip over the outer surface of the cathode current collector.

18. The electrochemical device of claim 16, wherein the current collector is an anode current collector electrically connected with the anode layer, and wherein the magnetic layer includes a magnetic coating covering the outer surface of the anode current collector.

19. The electrochemical device of claim 15, wherein the magnetic layer includes a ferromagnetic portion and a non-ferromagnetic portion.

20. The electrochemical device of claim 19, wherein the ferromagnetic portion includes a material having a relative magnetic permeability greater than 1,000.
